(19) United States
(12) Patent Application Publication
(10) Pub. No.: US 2015/0338832 A1
(43) Pub. Date: Nov. 26, 2015

(54) Method for the Safe Checking of a State of Two Devices and Apparatus for Carrying Out Said Method

(71) Applicant: SICK AG, Waldkirch (DE)

(72) Inventors: Franz DOLD, Waldkirch (DE); Markus SAUMER, Waldkirch (DE); Martin KUNZ, Waldkirch (DE)

(21) Appl. No.: 14/707,585

(22) Filed: May 8, 2015

(30) Foreign Application Priority Data
May 26, 2014 (EP) 14169788.8

(51) Int. Cl. G05B 9/02

(52) U.S. Cl. CPC G05B 9/02

(57) ABSTRACT

For the safe check of a state of an automation system using a simple, safe data transfer, a method is provided for a secure checking of a state of a first device and of a second device which are connected to one another via a first line and via a second line, wherein the first device transmits a signal characterizing the first device to the second device and receives the signal characterizing the first device back via the second line and the second device transmits a signal characterizing the second device via a second line to the first device and receives the signal characterizing the second device back via the first line, and wherein a defect case is determined on a change of one of the two signals.

### The invention relates to a method of checking a state of two devices and to an apparatus.

Data in an automation system are conventionally exchanged bidrectionally between the system devices using fieldbus protocols. In this respect the specific states of the system devices such as operation readiness or connection are e.g. prepared in message protocols.

The interfaces of each system device have to be configured from a technical hardware aspect such that they can both recognize and process message protocols to determine the states of the system devices from the message protocols and to initiate corresponding measures.

With a safe automation system, corresponding standards for a safe data transfer additionally have to be satisfied. For this purpose, at least one double wiring is conventionally provided between two system devices, i.e. between two uplines and two downlines, for a bidirectional 1-bit data transfer. The double wiring in turn requires four safe inputs and four safe outputs or eight safe communication interfaces in the respective system devices.

To transfer data information between two system devices or participants, corresponding safety measures are required against possible defects.

Such a safe data transfer in which the states of the system devices are safely communicated is thus of a technically complex design and effects high development costs and production costs for the automation system.

It is therefore an object of the invention to improve a method for a safe checking of a state of two devices such that a simple communication of the state is possible and a defect case can be reliably recognized.

The object is satisfied in accordance with the invention by a method for a safe checking of a state of a first device and of a second device which are connected to one another via a first line and via a second line, wherein the first device transmits a signal characterizing the first device to the second device via the first line and receives the signal characterizing the first device back via the second line and the second device transmits a signal characterizing the second device to the first device via the second line and receives the signal characterizing the second device back via the first line, and wherein a defect case is determined on a change of one of the two signals.

This has the advantage that the signal characterizing the device is communicated in the simplest manner, in particular in a redundant and diverse manner, by the system and in so doing the states of the device and lines connected to the transmitting device are also checked.

In accordance with a preferred embodiment, the signals characterizing the devices are output as a pulse pattern and a pulse pattern recognition of the pulse pattern is carried out.

In accordance with a further preferred embodiment, the signals characterizing the devices are output as a pulse pattern and a slope recognition of the pulse pattern is carried out.

It is determined in the slope recognition of the pulse pattern whether the signal has a low state or a high state. It can be derived from this without any further processing whether the devices and the lines are in a faultless state.

In accordance with a further preferred embodiment, the signal characterizing the first device internally short-circuits the second device and the signal characterizing the first device is passed through to the first device.

In accordance with a further preferred embodiment, the signal characterizing the second device internally short-circuits the first device and the signal characterizing the second device is passed through to the second device.

A simple communication setup without complex bus protocols and interfaces can hereby be achieved.

In accordance with a further preferred embodiment, the signals characterizing the devices are compared by a comparator and a shutting down of the devices is carried out on a deviation from an original state of the signal.

In accordance with a further preferred embodiment, information of the respective device is added to the signals characterizing the device using an AND gate. The information advantageously triggers a shutting down of the device. I.e. the information of the respective device is additionally also transmitted with the signals characterizing the device, with this information remaining out of consideration on the check of the states and serving for triggering an action.

The object is furthermore satisfied in accordance with the invention by an apparatus for a safe carrying out of an above-named method, comprising a first device and a second device which are connected to one another via a first line and via a second line, wherein the first and second devices each have an answerback unit which is provided for generating a signal characterizing the device and for transmitting the signal characterizing the device via the first line or via the second line to the connected other device, and wherein the respective answerback unit is configured for receiving the transmitted signal characterizing the device and for comparing the transmitted signals received back and characterizing the device such that a state of the connected other device and of the first line and of the second line can be safely evaluated.

In accordance with a preferred embodiment, the first device and the second device are respectively a sensor and a control, a control and an actuator or a respective separate control, which are connected to one another via the first and second lines.

In accordance with a further preferred embodiment, the signal characterizing the device comprises a pulse pattern and/or information on the respective device.

In accordance with a further preferred embodiment, the answerback unit comprises a control unit having a pulse pattern generator, a comparator and an AND gate.

In accordance with a further preferred embodiment, the answerback unit is configured for carrying out a pulse pattern recognition and/or a slope recognition of the signal characterizing the device.

In accordance with a further preferred embodiment, the information on the device includes state information of the device and/or a command for shutting down the device. It is hereby advantageously possible not only to communicate the state of the device and of the lines, but simultaneously also to trigger or initiate a measure in a simple manner.

The method in accordance with the invention and the apparatus in accordance with the invention can be designed in a similar manner by further features and show similar advantages in this respect. Such further features are described in an exemplary, but not exclusive, manner in the dependent claims following the independent claims.

The invention will also be explained in the following with respect to further advantages and features with reference to the enclosed drawing and to embodiments. The Figures of the drawing show in:

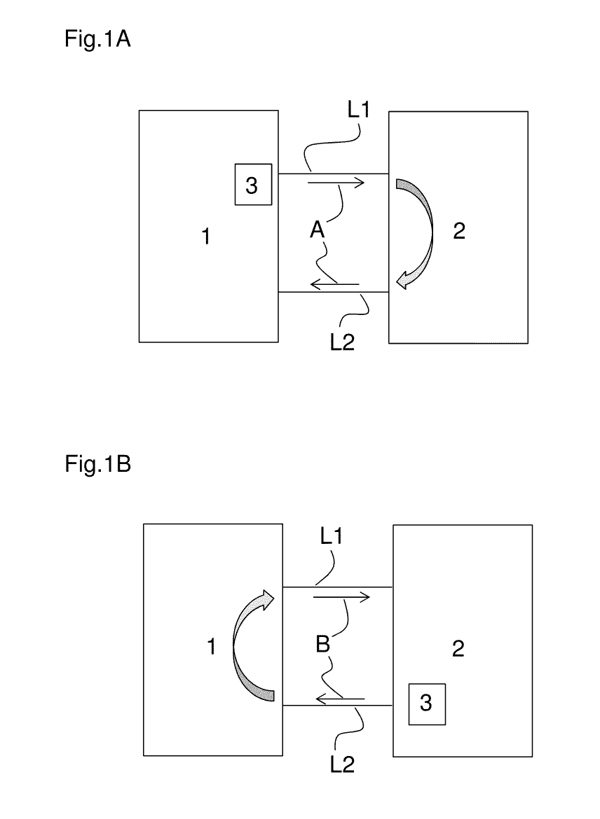

FIG. 1A a schematic representation of a routine in accordance with the invention;

FIG. 1B the schematic representation of the routine in accordance with the invention; and

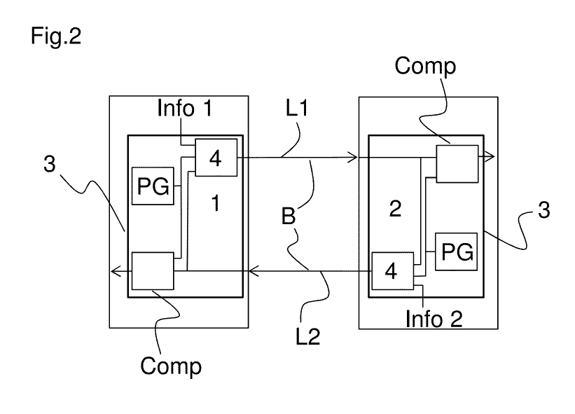

FIG. 2 a schematic detail representation of an answerback unit in accordance with the invention.

A schematic design of an apparatus comprising a first and a second device 1, 2 is shown in FIGS. 1A and 1B which are connected to one another via a first and a second line L1, L2 and which form an automation system. In this respect, the devices 1, 2 can comprise a safe sensor and an associated safe control, a safe control and an actuator driven by the safe control or two independent controls, preferably safety controls.

The first and second devices 1, 2 each have an answerback unit 3 which is provided for generating a signal A, B characterizing the device 1, 2 and for transmitting the signal A, B characterizing the device 1, 2 via the first and second lines L1, L2 to the connected other device 2, 1.

As shown in FIG. 1A, in accordance with the invention the answerback unit 3 of the first device 1 generates a signal A characterizing the first device 1 and transmits it via the first line L1 to the second device 2. The signal A characterizing the first device 1 internally short-circuits the second device 2 in a preferred manner, i.e. it internally triggers a test pulse in the second device 2 so that the signal A characterizing the first device 1 can be passed through, in a preferred manner together with the test pulse serving as additional information, to the first device 1 via the second line L2.

The answerback unit 3 of the first device 1 receives the transmitted signal A characterizing the first device back via the second line L2 and determines from it, in particular in a preferred manner together with the test pulse, a state of the second device 2 and the connected first and second lines L1, L2.

In accordance with FIG. 1B, in accordance with the invention, the answerback unit 3 of the second device 2 likewise generates a signal B characterizing the second device 2 and transmits it via the second line L2 to the first device 1. The signal B characterizing the second device 2 also internally short-circuits the first device 1 in a preferred manner, i.e. it internally triggers a test pulse in the first device so that the signal B characterizing the second device 2 can be passed through, in a preferred manner together with the test pulse serving as additional information, to the second device via the first line L1.

In this respect, the signals A, B are output as pulse patterns, wherein the signals A, B are advantageously generated independently of one another and can be diverse. The signals A, B furthermore do not have to be synchronized with one another.

The signals A, B characterizing the devices 1, 2 thus form redundant and diverse signals which are communicated between the devices 1, 2 via two different lines L1, L2. A safe check or data transfer in accordance with the standard IEC 61131 is thereby ensured despite a reduced number of lines and inputs and outputs of the devices 1, 2.

When determining the state of the first or second devices 1, 2, a pulse pattern recognition or a slope recognition of the pulse pattern can be carried out.

In the slope recognition of the pulse pattern, the recognition unit 3 determines whether the signal A, B characterizing the device 1, 2 has a low state or a high state. It can be deduced from this, without any further complex processing, whether the first and/or second device(s) 1, 2 and the lines L1, L2 are in a flawless state or not.

FIG. 2 shows the above-described schematic representation of a design in accordance with the invention of the automation system, wherein the answerback unit 3 is shown in more detail.

The answerback unit 3 preferably comprises a control unit having a pulse pattern generator PG, a comparator Comp and an AND gate 4, wherein the answerback unit 3 is further configured to carry out the pulse pattern recognition and/or the slope recognition of the signal A, B characterizing the first or second device 1, 2.

The pulse pattern generator PG advantageously generates the signal A, B characterizing the first or second device 1, 2 and forwards it to the AND gate 4 so that the generated pulse pattern can be sent to the respective other device 2, 1 in the form of the signal A, B.

In this respect, additional information Info 1, Info 2 relating to the respective device 1, 2 can be added to the pulse pattern or to the signal A, B characterizing the device 1, 2 by means of the AND gate 4. The information Info 1, Info 2 on the device 1, 2 includes state information of the device 1, 2. and/or a command to shut down the device 1, 2 so that, on a determination of a defect case, e.g. a short-circuit in one of the two lines L1, L2, the two devices 1, 2 can be safely shut down together.

The recognition of the defect case is achieved by the comparator Comp which compares the signals A, B characterizing the devices 1, 2 or the pulse patterns with the originally transmitted signals A, B or pulse patterns of the pulse pattern generator PG. On a change of the signals A, B or of the pulse patterns, a defect case of the automation plant is safely determined.

In the case of a flawless state of the devices 1, 2, i.e. no change of the signals A, B characterizing the devices 1, 2 or on a recognition of the correct pulse pattern of the respective devices 1, 2, the comparator Comp preferably forwards the additional information Info 1, Info 2 and/or carries out a command communicated as information Info 1, Info 2.

In accordance with the invention, the pulse pattern generator PG and the comparator Comp thus each check the lines L1, L2 or transfer paths so that, in the event of a defect on the line L1, L2, both safely recognize the defect case.

The method in accordance with the invention or the apparatus in accordance with the invention has the advantage with respect to a conventional safety apparatus, which requires four lines, four safety inputs and four safety outputs for a safe bidirectional 1-bit data transfer using a bus protocol between two devices 1, 2, that only one respective safety input and one respective safety output have to be provided for the first and second lines L1, L2.

Half of the wiring can thereby be reduced and the costs can be reduced to half the original costs.

If the method in accordance with the invention is applied to an interconnection between a safety control as a first device 1 and an actuator as a second device 2, the signal A characterizing the safety control as a first device 1 can be a shut-down signal communicated as additional information Info 1 to the actuator as a second device 2. The signal B characterizing the actuator as a second device 2 can in turn communicate a feedback on a successful shut-down as additional information Info 2 to the safety control as a first device 1.

In accordance with a further preferred embodiment of the method in accordance with the invention, on an interconnection between a safety switch in the sense of a sensor as a second device 2 and a safety control as a first device 1, the safety switch as the second device 2 can transfer a state, e.g. a monitored door (open/closed), to the safety control as the first device 1 with the signal B characterizing the safety switch. In contrast to this, the safety control as the first device 1 can communicate a state in the form of active/inactive to the safety switch as the second device 2 with the signal A characterizing the safety control. These states can advantageously be communicated as additional information Info 1, Info 2 to the characterizing signals A, B.

The principle of the redundant and diverse signals A, B is hereby maintained with a secure communication between two devices 1, 2.

The communication can thus be carried out in a simplified and safe manner since the signals A, B characterizing the devices 1, 2 differ from one another (diverse) and are communicated via different lines L1, L2 to preferred different points in time (redundant).

### REFERENCE NUMERAL LIST

1, 2 Device
3 Recognizing unit
4 AND gate
L1 line 1
L2 line 2
A, B Signal
Comp Comparator
Info 1, Information or command
Info 2
PG pulse pattern generator

1. A method for a safe checking of a state of a first and a second device which are connected to one another via a first and a second line, wherein the first device transmits a signal characterizing the first device via the first line to the second device and receives the signal characterizing the first device back via the second line and the second device transmits a signal characterizing the second device via the second line to the first device and receives the signal characterizing the second device back via the first line, and wherein a defect case is safely determined on a change of one of the two signals.

2. The method in accordance with claim 1, wherein the signals characterizing the devices are output as a pulse pattern and a pulse pattern recognition is carried out.

3. The method in accordance with claim 1, wherein the signals characterizing the devices are output as a pulse pattern and a slope recognition of the pulse pattern is carried out.

4. The method in accordance with claim 1, wherein the signal characterizing the first device internally short-circuits the second device and is passed through to the first device.

5. The method in accordance with claim 1, wherein the signal characterizing the second device internally short-circuits the first device and is passed through to the second device.

6. The method in accordance with claim 1, wherein the signals characterizing the devices are compared by a comparator and a safe shut-down of the devices is carried out on a deviation from an original state of the signal.

7. The method in accordance with claim 1, wherein information of the respective device is added to the signals characterizing the device by means of an AND gate.

8. The method in accordance with claim 7, wherein the information triggers a shut-down of the device.

9. An apparatus for carrying out a method for a safe checking of a state of a first and a second device which are connected to one another via a first and a second line, comprising a first and a second device which are connected to one another via a first and a second line, wherein the first and second devices each have an answerback unit which is provided for generating a signal characterizing the device and for transmitting the signal characterizing the device via the first or second line to the connected other device, and wherein the respective answerback unit is configured for receiving the transmitted signal characterizing the device and for comparing the transmitted signals received back and characterizing the device such that a state of the connected other device and of the first and second line can be safely evaluated.

10. The apparatus in accordance with claim 9, wherein the first device and the second device are respectively a sensor and a control, a control and an actuator or a respective separate control, which are connected to one another via the first and second lines.

11. The apparatus in accordance with claim 9, wherein the signal characterizing the device comprises a pulse pattern and/or information on the respective device.

12. The apparatus in accordance with claim 9, wherein the answerback unit comprises a control unit having a pulse pattern generator, a comparator and an AND gate.

13. The apparatus in accordance with claim 9, wherein the answerback unit is configured for carrying out a pulse pattern recognition and/or a slope recognition of the signal characterizing the device.

14. The apparatus in accordance with claim 11, wherein the information on the device includes state information of the device and/or a command to shut down the device.
